(19) United States
(12) Patent Application Publication
(10) Pub. No.: US 2023/0049127 A1
(43) Pub. Date: Feb. 16, 2023

(54) RAMMER WITH VIBRATION ISOLATION

(71) Applicant: MILWAUKEE ELECTRIC TOOL CORPORATION, Brookfield, WI (US)

(72) Inventors: Evan M. Glanzer, Milwaukee, WI (US); Joseph C. Reiter, Milwaukee, WI (US); Kyle A. Greunke, Auborndale, WI (US)

(21) Appl. No.: 17/885,937

(22) Filed: Aug. 11, 2022

Related U.S. Application Data
(60) Provisional application No. 63/232,008, filed on Aug. 11, 2021.

(51) Int. Cl. E02D 3/068; E01C 19/35; E01C 21/00; F16F 15/02

(52) U.S. Cl. CPC E02D 3/068; E01C 19/35; E01C 21/00; F16F 15/022

(57) ABSTRACT

A vibratory rammer includes an upper mass, a lower mass coupled to the upper mass, a longitudinal axis extending centrally through the upper mass and the lower mass, and a handle coupled to the upper mass with a handle vibration dampening mechanism that is configured to attenuate vibration transmitted to the handle. The handle is configured to support a user interface on a first side of the longitudinal axis. A motor is coupled to the upper mass and a drive mechanism is operably coupled to the motor and the lower mass. The drive mechanism configured to move the lower mass in a reciprocating manner. A battery provides power to the motor and is coupled to the upper mass with a battery vibration dampening mechanism that is configured to attenuate vibration transmitted to the battery. The battery positioned on a second side of the longitudinal axis opposite the first side.

### CROSS-REFERENCE TO RELATED APPLICATIONS

This application claims priority to co-pending U.S. Provisional Pat. Application No. 63/232,008 filed on Aug. 11, 2021, the entire content of which is incorporated herein by reference.

### FIELD OF THE INVENTION

The present invention relates to vibratory rammers and more specifically to isolation mechanisms for vibratory rammers.

### SUMMARY OF THE INVENTION

The present invention provides, in one independent aspect, a vibratory rammer including an upper mass, a lower mass coupled to the upper mass, a longitudinal axis extending centrally through the upper mass and the lower mass, and a handle coupled to the upper mass with a handle vibration dampening mechanism that is configured to attenuate vibration transmitted to the handle. The handle is configured to support a user interface on a first side of the longitudinal axis. The vibratory rammer also includes a motor coupled to the upper mass, a drive mechanism operably coupled to the motor and the lower mass, the drive mechanism configured to move the lower mass in a reciprocating manner, and a battery configured to provide power to the motor. The battery is coupled to the upper mass with a battery vibration dampening mechanism that is configured to attenuate vibration transmitted to the battery, and the battery is positioned on a second side of the longitudinal axis opposite the first side.

The present invention provides, in another independent aspect, a vibratory rammer including an upper mass, a lower mass coupled to the upper mass, a longitudinal axis extending centrally through the upper mass and the lower mass, a handle coupled to the upper mass with a handle vibration dampening mechanism that is configured to attenuate vibration transmitted to the handle, a motor coupled to the upper mass, a drive mechanism operably coupled to the motor and the lower mass, the drive mechanism configured to move the lower mass in a reciprocating manner, and a battery configured to provide power to the motor. The battery is coupled to a top portion of the upper mass with a battery vibration dampening mechanism that is configured to attenuate vibration transmitted to the battery. The battery vibration dampening mechanism has one or more elastomeric sandwich battery isolators coupled to the top portion of the upper mass and positioned between the battery and the upper mass.

The present invention provides, in another independent aspect, a vibratory rammer including an upper mass, a lower mass coupled to the upper mass, a longitudinal axis extending centrally through the upper mass and the lower mass, a handle coupled to the upper mass with a handle vibration dampening mechanism that is configured to attenuate vibration transmitted to the handle, the handle configured to support a user interface on a first side of the longitudinal axis, a motor coupled to the upper mass, a drive mechanism operably coupled to the motor and the lower mass, the drive mechanism configured to move the lower mass in a reciprocating manner, and a battery configured to provide power to the motor, the battery coupled to the upper mass with a battery vibration dampening mechanism that is configured to attenuate vibration transmitted to the battery, the battery positioned on the first side of the longitudinal axis.

Other features and aspects of the invention may be apparent upon considering the following detailed description and accompanying drawings.

### BRIEF DESCRIPTION OF THE DRAWINGS

FIG. 1 is a schematic view of a rammer according to an embodiment of the disclosure.

FIG. 2 is a schematic view of a rammer according to another embodiment of the disclosure.

FIG. 3 is a schematic view of a rammer according to another embodiment of the disclosure.

FIG. 4 is a schematic view of a rammer according to another embodiment of the disclosure.

FIG. 5 is a schematic view of a rammer according to another embodiment of the disclosure.

FIG. 6 is a schematic view of a rammer according to another embodiment of the disclosure.

FIG. 7 is a schematic view of a rammer according to another embodiment of the disclosure.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting.

### DETAILED DESCRIPTION

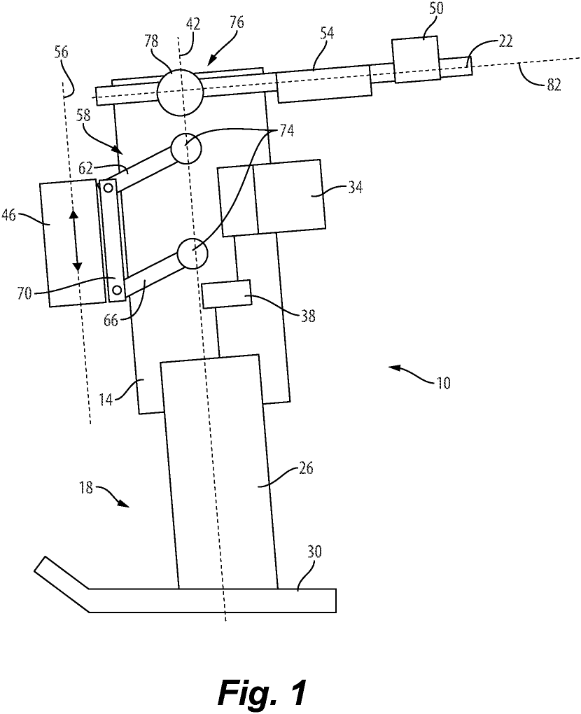

FIG. 1 illustrates a vibratory rammer 10 that includes an upper mass 14, a lower mass 18 coupled to and movable relative to the upper mass 14, and a handle 22 coupled to the upper mass 14. The lower mass 18 includes a lower mass main body 26 and a rammer plate 30 coupled to the lower mass main body 26. A motor 34 is coupled to the upper mass 14 and is operably coupled to a drive mechanism 38 to move the lower mass 18 relative to the upper mass 14. The rammer 10 also includes a longitudinal axis 42 that extends centrally through the upper mass 14 and the lower mass 18 and in a direction of the movement of the lower mass 18. In some embodiments, the drive mechanism 38 may include a crank mechanism coupled to the lower mass 18 and a gearset operably coupled to the motor 34, which drives the crank mechanism to move the lower mass 18 in a reciprocating manner along the longitudinal axis 42. In some embodiments, the gearset may be a reduction gearset so the lower mass 18 reciprocates at a frequency that is lower than a rotational frequency of an output shaft of the motor 34.

The rammer 10 also includes a battery 46 coupled to the upper mass 14, a user interface 50 coupled to the handle 22, and an electronic control unit 54 coupled to the handle 22. The user interface 50 may allow an operator to selectively provide power to the rammer 10, select a mode (e.g., high, medium, or low speed) for the motor 34 to operate, monitor the state of charge of the battery 46, and the like. The user interface 50 may also include an input device (e.g., a trigger) that is configured to receive a user input from the operator and a display (e.g., a LCD display) to display operational information (e.g., mode of the rammer 10, state of charge of the battery 46, work time remaining, etc.). The electronic control unit 54 may be in communication with the user interface 50, the battery 46, and/or the motor 34. The electronic control unit 54 may receive the user input from the user interface 50 to control the motor 34, monitor conditions of the rammer 10 via input from sensors, and the like.

The battery 46 is configured to power the motor 34 in response to the user input received by the user interface 50. The battery 46 also includes a battery axis 56 that extends centrally through the battery 46. The battery axis 60 is substantially parallel to the longitudinal axis 42 of the rammer 10. In addition, the battery 46 is positioned on a first, (e.g., front) side of the rammer 10, and the user interface 50 and the electronic control unit 54 are positioned on a second, (e.g., rear) side of the rammer 10. In other words, the battery 46 is positioned on an opposite side of the longitudinal axis 42 from the user interface 50 and the electronic control unit 54. In some embodiments, the battery 46 may have a nominal output voltage between 40-Volts and 80-Volts.

With continued reference to FIG. 1, the battery 46 is coupled to the upper mass 14 by a first, battery vibration dampening mechanism 58, which reduces the amount of vibration on the battery 46 during operation of the rammer 10. The battery vibration dampening mechanism 58 includes a linkage system having a first, upper link 62, a second, lower link 66, and a third, support link 70 extending between and connecting the first and second links 62, 66. The battery 46 may be removably coupled to a battery receptacle (not shown) fixed to the support link 70. In some embodiments, the battery 46 may be slidably coupled to the battery receptacle via a cooperating rail arrangement, and the battery 46 may be attached and detached from the receptacle by sliding the battery 46 along an axis parallel or coaxial with the battery axis 60.

A first end of the first link 62 is pivotally coupled to the upper mass 14, a first end of the second link 66 is pivotally coupled to the upper mass 14, and the support link 70 is pivotably coupled to a second end of each of the first and second links 62, 66. The battery vibration dampening mechanism 58 also includes linkage isolators 74 (e.g., elastomeric isolators), which are positioned between the first end of each of the first and second links 62, 66 and the upper mass 14.

In the illustrated embodiment, the first and second links 62, 66 are pivotally coupled to the upper mass 14 along the longitudinal axis 42 of the rammer 10. In other words, the first link 62 is coupled to the upper mass 14 at a first position along the longitudinal axis 42 and the second link 66 is coupled to the upper mass 14 at a second position along the longitudinal axis 42, which is a distance from the first position. Further, the length of the support link 70 is equal to the distance between the first and second positions at which the first and second link 66 are pivotally coupled to the upper mass 14. As a result, the linkage system may translate in such a way that the support link 70 and the battery 46 coupled thereto moves primarily parallel to and along the battery axis 56. The range of motion of the battery vibration dampening mechanism 58 is limited by a lower stop position, where the support link 70 contacts the upper mass 14, and an upper stop position, where the support link 70 also contacts the upper mass 14. The linkage isolators 74 are also configured to restrict movement of the linkage assembly near the upper and lower stop positions. In other words, the linkage isolators 74 are configured to absorb forces from the translational movement of the battery 46 along the battery axis 56 near the upper and lower stop positions, thereby protecting the battery 46 from being damaged by vibration.

The rammer 10 also includes a second, handle vibration dampening mechanism 76 positioned between the handle 22 and the upper mass 14, which reduces the amount of vibration transmitted from the upper mass 14 to the handle 22. In the illustrated embodiment, the handle vibration dampening mechanism 76 includes an elastomeric torsion handle isolator 78. In other embodiments, the handle vibration dampening mechanism 76 may be formed with an alternative construction and/or include more components to reduce the amount of vibration translated to the handle 22. The handle isolator 78 may pivotably couple the handle 22 to the upper mass 14.

Further, the handle 22 defines a handle axis 82 that is orthogonal to the longitudinal axis 42 and the battery axis 56. The handle isolator 78 is positioned at a location where the longitudinal axis 42 of the rammer 10 and the handle axis 82 intersect. The handle isolator 78 is also spaced along the longitudinal axis 42 from the linkage isolators 74 of the battery vibration dampening mechanism 58. In other words, the linkage isolators 74 and the handle isolator 78 are all positioned in a single plane along the longitudinal axis 42. As such, the handle 22 may pivot relative to the longitudinal axis 42 and the handle isolator 78 is configured to absorb forces and reduce vibration transmitted to the handle 22 and thereby reduces vibration transmitted to the user interface 50 and the electronic control unit 54.

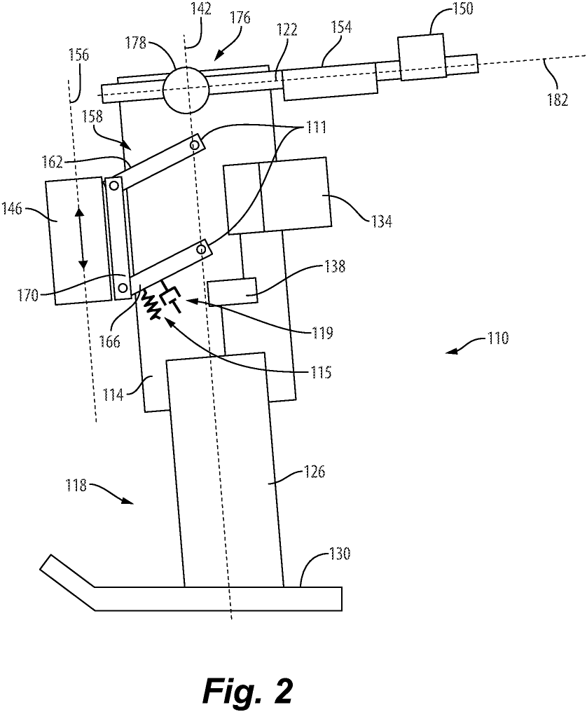

FIG. 2 illustrates a vibratory rammer 110 according to another embodiment of the disclosure. The rammer 110 is like the rammer 10 shown in FIG. 1 and described above. Therefore, like features are identified with like references numerals plus “100”, and only the differences between the two will be discussed.

The vibratory rammer 110 includes an upper mass 114, a lower mass 118 coupled to and movable relative to the upper mass 114, and a handle 122 coupled to the upper mass 114. The lower mass 118 includes a lower mass main body 126 and a rammer plate 130 coupled to the lower mass main body 126. A battery 146 is coupled to an upper mass 114 of the rammer 10 with a battery vibration dampening mechanism 158. The battery vibration dampening mechanism 158 includes a linkage system having a first, upper link 162, a second, lower link 166, and a third, support link 170 extending between and connecting the first and second links 162, 166. A first end of each of the first and second links 162, 166 are pivotally coupled to the upper mass 14 with pins 111 and the support link 166 is pivotably coupled to a second end of each of the first and second links 162, 166.

The battery vibration dampening mechanism 158 also includes a spring 115 and a damper 119, which are coupled to and extend between the linkage system and the upper mass 114. In the illustrated embodiment, the spring 115 and the damper 119 are each coupled to the lower, second link 166. In other embodiments, the spring 115 and damper 119 may be coupled to any combination of the other links of the linkage system (e.g., the first link 162, the support link 170). Further, the spring 115 and damper 119 may have a linear relation. The combination of the spring 115 and damper 119 are configured to attenuate vibration to the battery 146.

The range of motion of the battery vibration dampening mechanism 158 is limited by a lower stop position, where the support link 170 contacts the upper mass 114, and an upper stop position, where the support link 170 also contacts the upper mass 114. The spring 115 and damper 119 are configured to restrict movement of the linkage assembly near the upper and lower stop positions. In other words, the spring 115 and damper 119 are configured to absorb forces from the translational movement of the battery 146 along the battery axis 156 near the upper and lower stop positions, thereby protecting the battery 146 from being damaged by vibration.

The rammer 110 also includes a second, handle vibration dampening mechanism 176 positioned between the handle 122 and the upper mass 114, which reduces the amount of vibration transmitted from the upper mass 114 to the handle 122. In the illustrated embodiment, the handle vibration dampening mechanism 176 includes an elastomeric torsion handle isolator 178 that may pivotably couple the handle 122 to the upper mass 114. Further, the handle 122 defines a handle axis 182 that is orthogonal to the longitudinal axis 142 and the battery axis 156. The handle isolator 178 is positioned at a location where the longitudinal axis 142 of the rammer 110 and the handle axis 182 intersect. The handle isolator 178 is also spaced along the longitudinal axis 142 from the pins 111 of the battery vibration dampening mechanism 158.

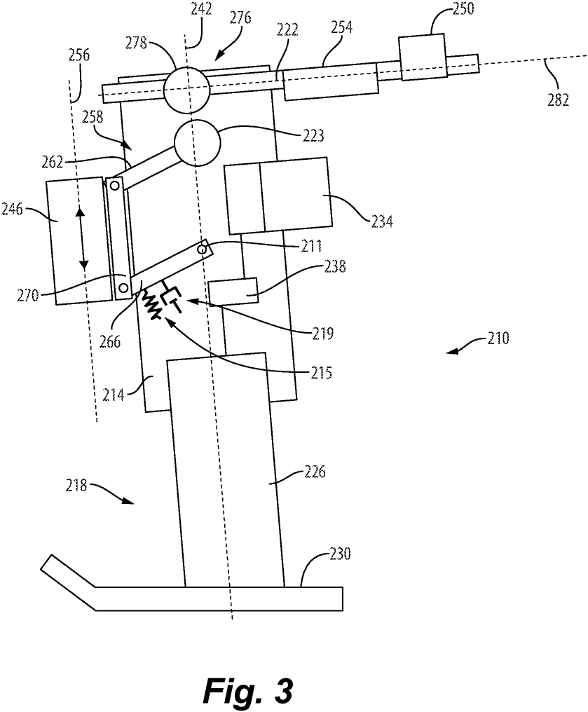

FIG. 3 illustrates a vibratory rammer 210 according to another embodiment of the disclosure. The rammer 210 is like the rammer 10 shown in FIG. 1 and described above. Therefore, like features are identified with like references numerals plus “200”, and only the differences between the two will be discussed.

The vibratory rammer 210 includes an upper mass 214, a lower mass 218 coupled to and movable relative to the upper mass 214, and a handle 222 coupled to the upper mass 214. The lower mass 218 includes a lower mass main body 226 and a rammer plate 230 coupled to the lower mass main body 226. A battery 246 is coupled to the upper mass 214 with a battery vibration dampening mechanism 258, which reduces the amount of vibration on the battery 246 during operation of the rammer 210. The battery vibration dampening mechanism 258 includes a linkage system having a first, upper link 262, a second, lower link 266, and a third, support link 270 extending between and connecting the first and second links 162, 166. A first end of the first link 162 is pivotably coupled to a secondary motor 223, a first end of the second link 266 is pivotally coupled to the upper mass 214 with a pin 211, and the support link 270 is pivotably coupled to a second end of each of the first and second links 262, 266. In other embodiments, the secondary motor 223 may be coupled to the second link 266.

The battery vibration dampening mechanism 258 also includes a spring 215, a damper 219, and the secondary motor 223, which are each coupled to and extend between the linkage system and the upper mass 214. In the illustrated embodiment, the spring 215 and the damper 219 are each coupled to the lower, second link 266 and the secondary motor 223 is coupled to the first end of the upper, first link 262. In other embodiments, the spring 215 and damper 219 may be coupled to any combination of the other links of the linkage system (e.g., the first link 262, the support link 270, etc.). The secondary motor 223 may be a servo motor that is configured to control the position of the battery 246 along the battery axis 256, in response to a signal from the electronic control system 240. For example, the electronic control system 240 may detect a property (e.g., speed, position, etc.) of the battery 246 and may send a signal to the secondary motor 223 to attenuate the vibration on the battery 246. The secondary motor 223 may also be used to improve tool performance by increasing and decreasing travel speed of the battery 246 and/or increasing and decreasing compaction ability of the battery 246. As such, the combination of the spring 215, the damper 219, and the secondary motor 223 are configured to attenuate vibration to the battery 246.

The rammer 210 also includes a second, handle vibration dampening mechanism 276 positioned between the handle 222 and the upper mass 214, which reduces the amount of vibration transmitted from the upper mass 214 to the handle 222. In the illustrated embodiment, the handle vibration dampening mechanism 276 includes an elastomeric torsion handle isolator 278 that may pivotably couple the handle 222 to the upper mass 214. Further, the handle 222 defines a handle axis 282 that is orthogonal to the longitudinal axis 242 and the battery axis 256. The handle isolator 278 is positioned at a location where the longitudinal axis 242 of the rammer 210 and the handle axis 282 intersect. The handle isolator 278 is also spaced along the longitudinal axis 242 from the secondary motor 223 and pin 211 of the battery vibration dampening mechanism 258.

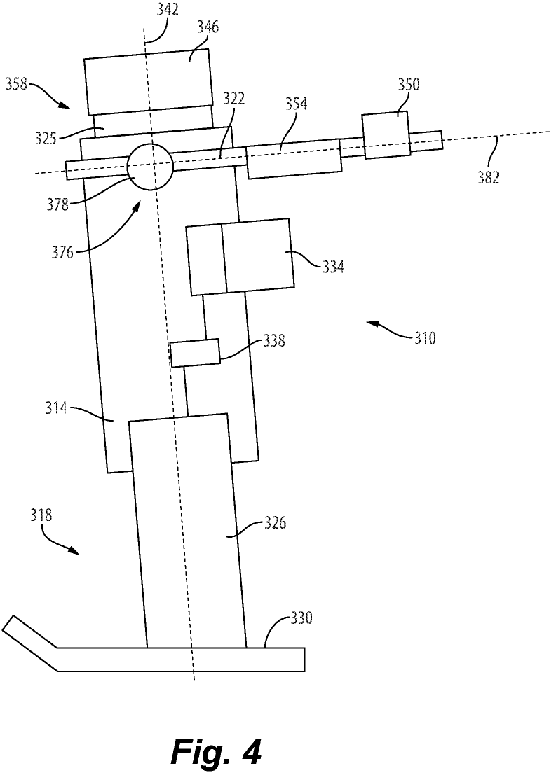

FIG. 4 illustrates a vibratory rammer 310 according to another embodiment of the disclosure. The rammer 310 is like the rammer 10 shown in FIG. 1 and described above. Therefore, like features are identified with like references numerals plus “300”, and only the differences between the two will be discussed.

The vibratory rammer 310 includes an upper mass 314, a lower mass 318 coupled to and movable relative to the upper mass 314, and a handle 322 coupled to the upper mass 314. The lower mass 318 includes a lower mass main body 326 and a rammer plate 330 coupled to the lower mass main body 326. The rammer 310 also includes a longitudinal axis 342 that extends centrally through the upper mass 314 and the lower mass 318 and a battery 346 coupled to a top portion of the upper mass 314 with a battery vibration dampening mechanism 358.

The battery vibration dampening mechanism 358 includes a battery isolator 325, is coupled to the top portion of the upper mass 314 (i.e. opposite the lower mass 318) and is positioned between battery 346 and the upper mass 314. In other words, the battery isolator 325 is between the battery 346 and the upper mass 314 such that the battery 346 and the upper mass 314 do not make direct contact. In some embodiments, the battery isolator 325 may be formed as one or more elastomeric sandwich isolator(s). In the illustrated embodiment, the battery 346 is positioned such that the longitudinal axis 342 extends centrally through the battery 346. The battery isolator 325 isolates the battery 346 from the mechanical vibrations during operation of the rammer 10, thereby preventing the battery 346 from being damaged by the vibrations of the rammer 10.

The rammer 310 also includes a second, handle vibration dampening mechanism 376 positioned between the handle 322 and the upper mass 314. In the illustrated embodiment, the handle vibration dampening mechanism 376 includes an elastomeric torsion handle isolator 378 that may pivotably couple the handle 322 to the upper mass 314. Further, the handle 322 defines a handle axis 382 that is orthogonal to the longitudinal axis 342. The handle isolator 378 is positioned at a location where the longitudinal axis 342 of the rammer 310 and the handle axis 382 intersect. The handle isolator 378 is also spaced along the longitudinal axis 342 from the battery isolator 325 of the battery vibration dampening mechanism 358.

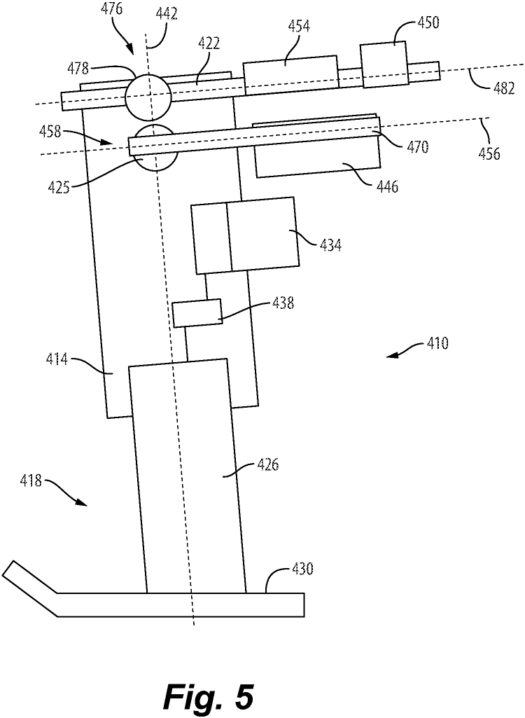

FIG. 5 illustrates a vibratory rammer 410 according to another embodiment of the disclosure. The rammer 410 is like the rammer 10 shown in FIG. 1 and described above. Therefore, like features are identified with like references numerals plus “400”, and only the differences between the two will be discussed.

The vibratory rammer 410 includes an upper mass 414, a lower mass 418 coupled to and movable relative to the upper mass 414, and a handle 422 coupled to the upper mass 414. The lower mass 418 includes a lower mass main body 426 and a rammer plate 430 coupled to the lower mass main body 426. A battery 446 is coupled to an upper mass 414 of the rammer 410 with a battery vibration dampening mechanism 458. The battery vibration dampening mechanism 458 includes a support link 470 (e.g., a sub-frame) having a first end pivotally coupled to the upper mass 414 and a second end coupled to the battery 446 and a battery isolator 425 that pivotably couples the support link 470 to the upper mass 414. In the illustrated embodiment, the battery 446 is oriented on the same side of the rammer 410 as a user interface 454, which is supported on the handle 422. The battery isolator 474 is configured to restrict the pivotal movement of the support link 470 and therefore the battery 446 between upper and lower stop positions, thereby protecting the battery 446 from being damaged by vibration

The rammer 410 also includes a second, handle vibration dampening mechanism 476 positioned between the handle 422 and the upper mass 414. In the illustrated embodiment, the handle vibration dampening mechanism 476 includes an elastomeric torsion handle isolator 478 that may pivotably couple the handle 422 to the upper mass 414. The support link 470 further supports the battery 446 such that a battery axis 456, which extends through the battery 446, is parallel to a handle axis 482 when the battery 446 is in a neutral position. The battery axis 456 and the handle axis 482 are also orthogonal to a longitudinal axis 42 of the rammer 410. The battery and handle isolators 474, 478 are each positioned at a location where the longitudinal axis 442 of the rammer 410 intersects the handle axis 482 and the battery axis 456, respectfully. In addition, the handle isolator 478 is also spaced along the longitudinal axis 442 from the battery isolator 425 of the battery vibration dampening mechanism 458.

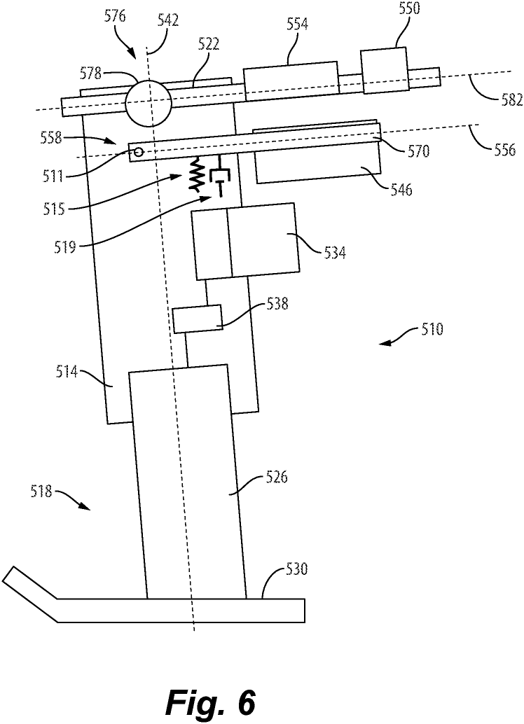

FIG. 6 illustrates a vibratory rammer 510 according to another embodiment of the disclosure. The rammer 510 is like the rammer 10 shown in FIG. 1 and described above. Therefore, like features are identified with like references numerals plus “500”, and only the differences between the two will be discussed.

The vibratory rammer 510 includes an upper mass 514, a lower mass 518 coupled to and movable relative to the upper mass 514, and a handle 522 coupled to the upper mass 514. The lower mass 518 includes a lower mass main body 526 and a rammer plate 530 coupled to the lower mass main body 526. A battery 546 is coupled to an upper mass 514 of the rammer 510 with a battery vibration dampening mechanism 558. The battery vibration dampening mechanism 558 includes a support link 570 (e.g., a sub-frame) having a first end pivotally coupled to the upper mass 514 with a pin 511 and a second end coupled to the battery 546. In the illustrated embodiment, the battery 546 is oriented on the same side of the rammer 510 as a user interface 554, which is supported on the handle 522. The battery vibration dampening mechanism 558 also includes a spring 515 and a damper 519, which are coupled to and extend between the support link 570 and the upper mass 514. The spring 515 and the damper 519 may have a linear relation to attenuate vibration to the battery 546. The spring 515 and the damper 519 are each configured to restrict the pivotal movement of the support link 570 and therefore the battery 546 between upper and lower stop positions, thereby protecting the battery 546 from being damaged by vibration.

The rammer 510 also includes a second, handle vibration dampening mechanism 576 positioned between the handle 522 and the upper mass 514. In the illustrated embodiment, the handle vibration dampening mechanism 576 includes an elastomeric torsion handle isolator 578 that may pivotably couple the handle 522 to the upper mass 514. The support link 570 further supports the battery 546 such that a battery axis 556, which extends through the battery 546, is parallel to a handle axis 582 when the battery 546 is in a neutral position. The battery axis 556 and the handle axis 582 are also orthogonal to a longitudinal axis 542 of the rammer 510.

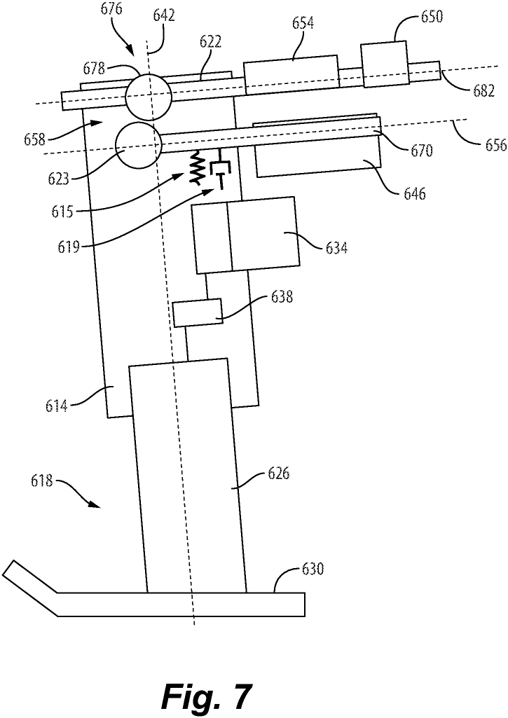

FIG. 7 illustrates a vibratory rammer 610 according to another embodiment of the disclosure. The rammer 610 is like the rammer 10 shown in FIG. 1 and described above. Therefore, like features are identified with like references numerals plus “600”, and only the differences between the two will be discussed.

The vibratory rammer 610 includes an upper mass 614, a lower mass 618 coupled to and movable relative to the upper mass 614, and a handle 622 coupled to the upper mass 614. The lower mass 618 includes a lower mass main body 626 and a rammer plate 630 coupled to the lower mass main body 626. A battery 646 is coupled to an upper mass 614 of the rammer 610 with a battery vibration dampening mechanism 658. The battery vibration dampening mechanism 658 includes a support link 670 (e.g., a sub-frame) having a first end pivotally coupled to the upper mass 614 and a second end coupled to the battery 646. In the illustrated embodiment, the battery 646 is oriented on the same side of the rammer 610 as a user interface 654, which is supported on the handle 622.

The battery vibration dampening mechanism 658 also includes a spring 615, a damper 619, and a secondary motor 623, which are each coupled to and extend between the support link 670 and the upper mass 614. The secondary motor 623 may be a servo motor that is configured to control the pivotable movement of the support link 670 and therefore the battery 646, in response to a signal from an electronic control system 640. For example, electronic control system 640 may detect a property (e.g., speed, position, etc.) of the support link 670 and may send a signal to the secondary motor 623 to attenuate the vibration on the battery 646. The secondary motor 623 may also be used to improve tool performance by increasing and decreasing travel speed of the support link 670 and/or increasing and decreasing compaction ability of the support link 670. As such, the combination of the spring 615, the damper 619, and the secondary motor 623 are configured to attenuate vibration to the battery 646.

The rammer 610 also includes a second, handle vibration dampening mechanism 676 positioned between the handle 622 and the upper mass 614. In the illustrated embodiment, the handle vibration dampening mechanism 676 includes an elastomeric torsion handle isolator 678 that may pivotably couple the handle 622 to the upper mass 614. The support link 670 further supports the battery 646 such that a battery axis 656, which extends through the battery 646, is parallel to a handle axis 682. The battery axis 656 and the handle axis 682 are also orthogonal to a longitudinal axis 642 of the rammer 610.

Although the invention has been described in detail with reference to certain preferred embodiments, variations and modifications exist within the scope and spirit of one or more independent aspects of the invention as described.

Various features and aspects of the invention are set forth in the following claims.

What is claimed is:

1. A vibratory rammer comprising:
an upper mass;
a lower mass coupled to the upper mass;
a longitudinal axis extending centrally through the upper mass and the lower mass;
a handle coupled to the upper mass with a handle vibration dampening mechanism that is configured to attenuate vibration transmitted to the handle, the handle configured to support a user interface on a first side of the longitudinal axis;
a motor coupled to the upper mass;
a drive mechanism operably coupled to the motor and the lower mass, the drive mechanism configured to move the lower mass in a reciprocating manner; and
a battery configured to provide power to the motor, the battery coupled to the upper mass with a battery vibration dampening mechanism that is configured to attenuate vibration transmitted to the battery, the battery positioned on a second side of the longitudinal axis opposite the first side.

2. The vibratory rammer of claim 1, wherein the battery vibration dampening mechanism comprises a linkage system including an upper link, a lower link, and a support link.

3. The vibratory rammer of claim 2, wherein the battery is coupled to the support link.

4. The vibratory rammer of claim 2, wherein the battery vibration dampening mechanism further comprises a spring and a damper, the spring and the damper each coupled to and extending between the linkage system and the upper mass.

5. The vibratory rammer of claim 4, wherein the spring and the damper are coupled to the lower link of the linkage system.

6. The vibratory rammer of claim 2, wherein the battery vibration dampening mechanism further comprises a secondary motor coupled to one or more of the upper link, the lower link, or the support link.

7. The vibratory rammer of claim 2, wherein a range of motion of the linkage system is defined by a lower position, in which the support link contacts the upper mass, and an upper position, in which the support link also contacts the upper mass.

8. The vibratory rammer of claim 2, wherein a first end of the upper link is pivotally coupled to the upper mass, a first end of the lower link is pivotally coupled to the upper mass, and the support link is pivotably coupled to a second end of each of the upper and lower links.

9. The vibratory rammer of claim 8, wherein locations at which the upper link and the lower link are pivotally coupled to the upper mass are on the longitudinal axis, and a length of the support link is equal to a distance between the locations at which the upper link and the lower link are pivotally coupled to the upper mass.

10. The vibratory rammer of claim 8, wherein the battery vibration dampening mechanism further comprises linkage isolators positioned between the first end of each of the upper and lower links and the upper mass.

11. The vibratory rammer of claim 10, wherein the handle vibration dampening mechanism is positioned at a location where the longitudinal axis of the vibratory rammer intersects a handle axis that extends centrally through the handle, and wherein the handle vibration dampening mechanism is spaced along the longitudinal axis from the linkage isolators.

12. The vibratory rammer of claim 11, wherein the handle axis is orthogonal to the longitudinal axis and a battery axis that extends centrally through the battery.

13. The vibratory rammer of claim 1, wherein:
the battery includes a battery axis that extends centrally through the battery,
the battery axis is parallel to the longitudinal axis, and
the battery vibration dampening mechanism allows the battery to translate along the battery axis.

14. The vibratory rammer of claim 1, further comprising an electronic control unit coupled to the handle.

15. A vibratory rammer comprising:
an upper mass;
a lower mass coupled to the upper mass;
a longitudinal axis extending centrally through the upper mass and the lower mass;
a handle coupled to the upper mass with a handle vibration dampening mechanism that is configured to attenuate vibration transmitted to the handle;
a motor coupled to the upper mass;
a drive mechanism operably coupled to the motor and the lower mass, the drive mechanism configured to move the lower mass in a reciprocating manner;
a battery configured to provide power to the motor, the battery coupled to a top portion of the upper mass with a battery vibration dampening mechanism that is configured to attenuate vibration transmitted to the battery, the battery vibration dampening mechanism having one or more elastomeric sandwich battery isolators coupled to the top portion of the upper mass and positioned between the battery and the upper mass.

16. The vibratory rammer of claim 15, wherein the elastomeric sandwich isolator is positioned between the upper mass and the battery such that the battery does not make direct contact with the upper mass.

17. The vibratory rammer of claim 15, wherein the battery is coupled to the upper mass is located on an uppermost surface of the upper mass.

18. A vibratory rammer comprising:
an upper mass;
a lower mass coupled to the upper mass;
a longitudinal axis extending centrally through the upper mass and the lower mass;
a handle coupled to the upper mass with a handle vibration dampening mechanism that is configured to attenuate vibration transmitted to the handle, the handle configured to support a user interface on a first side of the longitudinal axis;
a motor coupled to the upper mass;
a drive mechanism operably coupled to the motor and the lower mass, the drive mechanism configured to move the lower mass in a reciprocating manner; and
a battery configured to provide power to the motor, the battery coupled to the upper mass with a battery vibration dampening mechanism that is configured to attenuate vibration transmitted to the battery, the battery positioned on the first side of the longitudinal axis.

19. The vibratory rammer of claim 18, wherein the battery vibration dampening mechanism comprises a support link having a first end pivotably coupled to the upper mass and a second end coupled to the battery.

20. The vibratory rammer of claim 19, wherein the battery vibration dampening mechanism comprises a battery isolator that pivotably couples the support link to the upper mass.

21. The vibratory rammer of claim 19, wherein the battery vibration dampening mechanism comprises a spring and a damper which are coupled to and extend between the support link and the upper mass.

22. The vibratory rammer of claim 19, wherein the battery vibration dampening mechanism comprises a secondary motor coupled to the support link.

23. The vibratory rammer of claim 19, wherein the support link supports the battery such that a battery axis that extends through the battery is parallel to a handle axis that extends centrally through the handle.
